(19) United States
(12) Patent Application Publication
(10) Pub. No.: US 2009/0077568 A1
(43) Pub. Date: Mar. 19, 2009

(54) System and method for adjusting message hold time

(75) Inventors: Chaucer Chiu, Taipei (TW); Gost Ye, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/898,825

(22) Filed: Sep. 17, 2007

(51) Int. Cl. G06F 3/00

(52) U.S. Cl. 719/314

(57) ABSTRACT

A system and a method for adjusting message hold time to solve the problem that message hold time is invariable and cannot be changed are provided. The system adjusts the message hold time according to the difference in browsing speeds of a user in consecutive operations, so that the user may feel easy in operation after the message hold time is adjusted.

### BACKGROUND OF THE INVENTION

1. Field of Invention

The present invention relates to a system and a method for adjusting message hold time, and more particularly to a system and a method for adjusting message hold time according to the variation of the browsing speed of a user in consecutive operations.

2. Related Art

Any system executed in any kind of computer has the function of displaying messages. For example, in a game system, when a preset event is triggered in a scene, a message will be displayed; and in an application system, when a specific event is triggered, a message will also be displayed. The display of messages represents that the system prompts a user to operate the next instruction according to the message. However, the hold time of these messages is designed to be invariable in the system. As a result, some users may complain that the message hold time is too short or some may complain too long. Although in some systems, the user is allowed to adjust and set the message hold time according to the system design, the user merely can select from some given hold time periods, and even if the systems provides the chance for the user to adjust the message hold time, it is merely an acceptable solution for the user to select after comparison, and the adjustment requirements of different users and different applications cannot be satisfied yet. The most important is that the message hold time cannot be adjusted according the actual browsing speed from the user.

In fact, in some circumstances, the user hopes that when a system executed by a computer is used, the message may hold for a long time and will not be switched off or closed until the user operates to response it, while sometimes, the user hopes that the message may be switched or closed as soon as possible. If the message hold time is always very long, when operating the computer or playing a game, the user has to wait a quite long time for it is common that more than one message is displayed simultaneously. On the contrary, if the message hold time is always too short, when operating the computer or playing a game, the user possibly misses a lot of messages. In other words, it will be difficult for the user to feel easy in operation if the message hold time is always controlled by a constant method or by a method set by user.

Therefore, it is necessary to provide a specific solution to solve the problem in the conventional technology of controlling the message hold time.

### SUMMARY OF THE INVENTION

In view of the aforementioned problem in the prior art that the message hold time is invariable and cannot be adjusted in response to different applications, the present invention is directed to provide a system and a method for adjusting message hold time, so as to solve the problem in the message hold time.

As for the system and method for adjusting message hold time disclosed in the present invention, the composition and operating steps are as follows. A detection and operation module is used to activate a counter unit to count time when detecting that a message is triggered, make the counter unit stop counting when receiving a response of operation of a user, and then calculate a browsing speed from the user in this operation. A comparison module storing a previous browsing speed from the user is used to compare this browsing speed with the previous browsing speed to acquire a difference. An adjusting module is used to adjust the message hold time required by the user according to the difference.

Furthermore, the present invention further includes a parameter setting module used to store a basic hold time parameter for adjusting the message hold time. When this browsing speed is lower than the previous browsing speed, the message hold time for the user must be shortened, i.e., the basic hold time parameter is subtracted from the original message hold time. On the contrary, when this browsing speed is higher than the previous browsing speed, the message hold time for the user must be prolonged, i.e., the basic hold time parameter is added to the original message hold time. The adjusted message hold time and this browsing speed will be recorded and stored as reference information of the next adjustment.

In order to avoid adjusting the message hold time too frequently and trivially, in the present invention, a predetermined threshold value is further set for sifting adjustment. If the absolute value of the difference does not exceed the predetermined threshold value or an abnormal event occurs when this browsing speed is calculated, the adjustment will not be performed, so as not to cause much load on the system efficiency. Compared with the prior art, the present invention may instantly adjust the message hold time according to the actual response from the user on the message which can make the users feel easy in operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a block diagram of the system for adjusting message hold time according to the present invention.

FIG. 2 is a flow chart of the method for adjusting message hold time according to the present invention.

FIG. 3 is a time diagram for adjusting the message hold time by using the present invention.

### DETAILED DESCRIPTION OF THE INVENTION

The features and practice of the present invention will be illustrated below in detail with reference to the drawings.

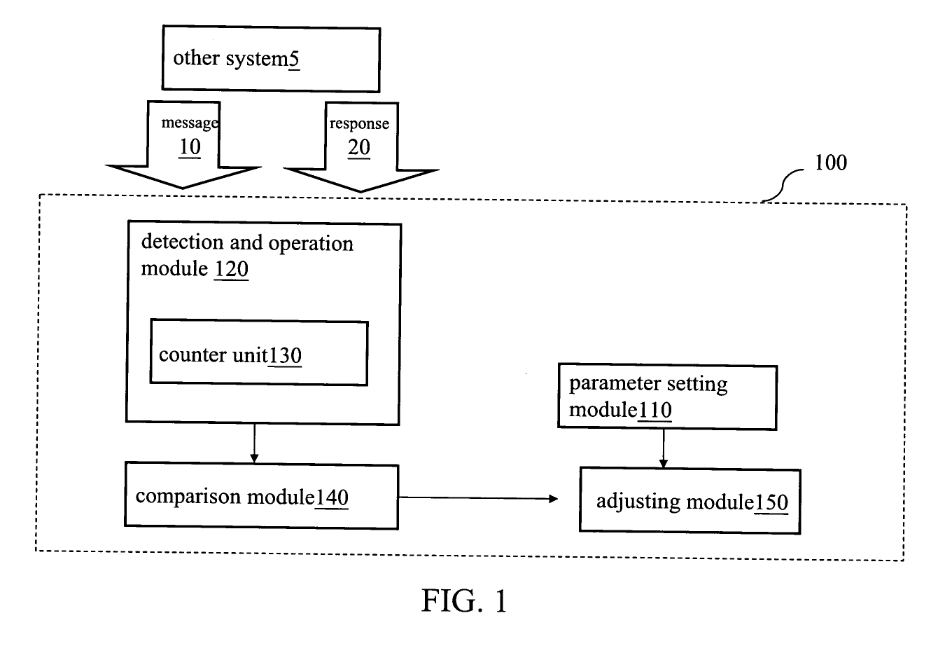

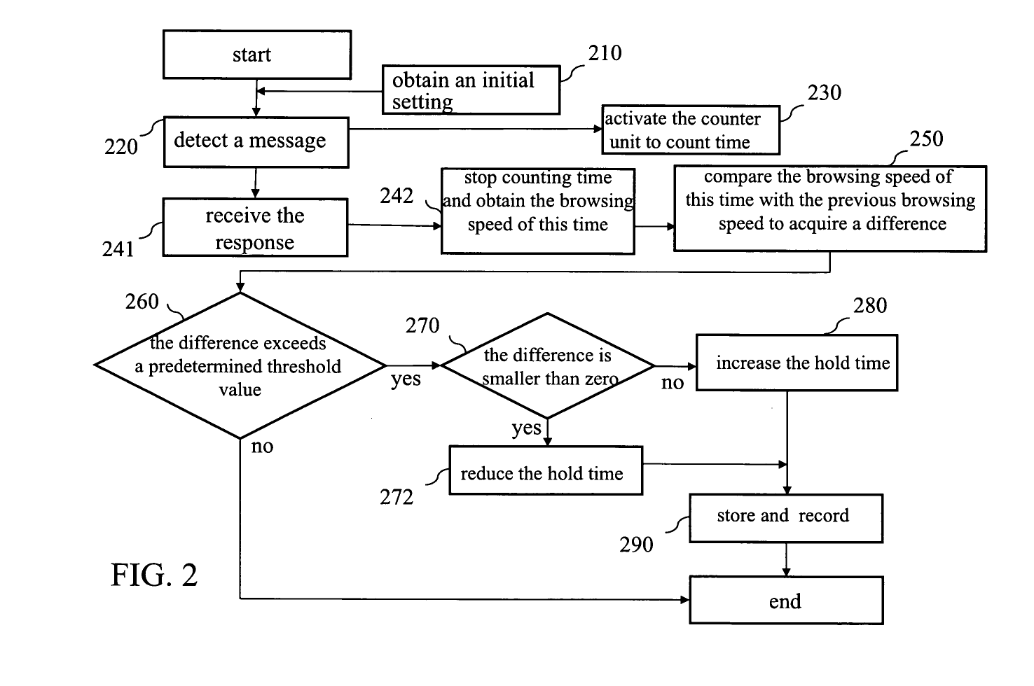

The present invention mainly provides a system and a method for adjusting message hold time. The system and method may be applied in a computer executable platform which also executes other software systems with prompt messages. The illustration is provided with reference to the system block diagram of FIG. 1 and the flow chart of FIG. 2.

The adjusting message system 100 disclosed in the present invention firstly acquires a basic hold time parameter through a parameter setting module 110 at the very beginning (Step 210). The basic hold time parameter is a basic adjustment unit for adjusting the message hold time, and may be a time unit, such as minute, second, microsecond, and millisecond, or a percentage of browsing time (e.g., 1% of browsing time). The message hold time refers to the basic hold time initially set by the adjusting message system 100, and can use the time unit, such as minute, second, microsecond, and millisecond.

Next, the adjusting message system 100 continuously detects whether an event that a message 10 is triggered occurs. Generally, the triggered event comes from another system 5. When the adjusting message system 100 detects that the message 10 is triggered (Step 220), a detection and operation module 120 activates a counter unit 130 to start counting time (Step 230), and when receiving a response 20 of the operation from the user (Step 241), the detection and operation module 120 makes the counter unit 130 stop counting time and then obtains a browsing speed of this time (Step 242). The calculation method is that the browsing time is divided by a total number of separate words, a total number of message lines, and a total number of message pages in the message, and the total number of separate words, the total number of message lines, and the total number of message pages may be provided by another system 5 which causes a triggered event. Then, a comparison module 140 is used to acquire a difference between the browsing speed of this time and the previous browsing speed from the user (Step 250). The previous browsing speed may be set according to an average browsing speed measured in the first operation with which common people browse separate words, the message in a single line, and the messages in a single page, and the calculation method is that the total number of separate words, the total number of message lines, and the total number of message pages are divided by the browsing time, so as to calculate the separate words, the message lines, and the message pages browsed in a time unit, or the calculation method is that the browsing time is divided by the total number of separate words, the total number of message lines, and the total number of message pages, so as to calculate the time spent in browsing each word, message line, and message page. Of course, such a value may be set in the comparison module 140 upon the user's actual requirements. In the present invention, “the time for browsing each separate word” is used as the “browsing speed” in the following paragraphs.

In order to avoid adjusting the message hold time too frequently and trivially, the comparison module 140 further has a predetermined threshold value. When an absolute value of the difference between the browsing speed of this time and the previous browsing speed is smaller than the predetermined threshold value, it indicates that the difference between the response time of consecutive operations from the user is not obvious. Therefore, the message hold time will not be adjusted at all, i.e., the adjusting module 150 is disabled (Step 260). For example, if the predetermined threshold value is set as 1 second per word, when the absolute value of the difference between the browsing speed of this time and the previous browsing speed is smaller than 1 second per word (i.e., the browsing speed of this time is higher than the previous browsing speed by less than 1 second, or the browsing speed of this time is lower than the previous browsing speed by less than 1 second), it is considered that the response from the user does not change obviously. Therefore, the message hold time will not be adjusted, and the response 20 from the user will be detected again when the next message 10 is triggered, so as to calculate the difference again. In addition, if the detection and operation module 120 calculates the browsing speed of this time to be an abnormal event, for example, the user spends more than 60 seconds in browsing each word, the message hold time will not be adjusted, either, i.e., the adjusting module 150 is disabled to stop adjusting the message hold time.

If it is determined that the absolute value of the difference exceeds the predetermined threshold value (i.e., the browsing speed of this time from the user is higher/lower than the previous browsing speed by 1 second), it indicates that the message hold time should be adjusted, but before adjustment, it should be determined firstly whether to prolong or shorten the message hold time. At this point, subtract the previous browsing speed from that of this time and then get the difference (Step 250). Next, determine whether the difference is smaller than zero (Step 270). If the browsing speed of this time from the user is higher than the previous browsing speed (i.e., the difference is smaller than zero), the predetermined basic hold time parameter is subtracted from the message hold time, so as to shorten the message hold time (Step 272). On the contrary, if the browsing speed of this time is lower than the previous browsing speed (i.e., the difference is greater than zero), the basic hold time parameter is added to the message hold time, so as to prolong the message hold time (Step 280).

Finally, after the adjustment is finished, the storing and recording procedure is performed (Step 290), which includes two following parts. (1) The adjusting module 150 sends a request to ask the comparison module 140 to replace the originally stored previous browsing speed with the browsing speed of this time as the previous browsing speed of the next adjustment; and (2) the adjusting module 150 also records the adjusted message hold time to be a result for the use of the subsequent adjusting procedure.

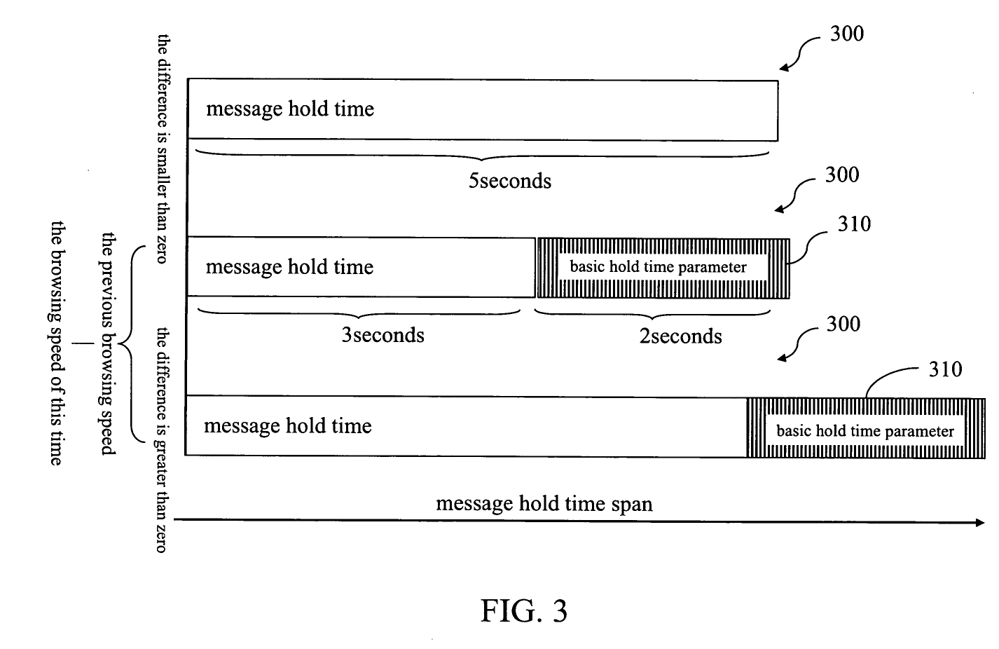

FIG. 3 is a time diagram for adjusting the message hold time by using the adjusting message system 100 disclosed in the present invention, so as to simply illustrate an embodiment of adjusting the message hold time. Herein, the preconditions of the embodiment are firstly assumed, in which the message hold time 300 (the basic hold time is initially set as 5 seconds); the basic adjustment unit of the basic hold time parameter 310 prestored for adjusting the message hold time 300 is 2 seconds; and the record of the previous browsing speed from the user is 0.5 seconds per word (indicating that the user spent 5 seconds in browsing 10 words). Therefore, if it is determined that the difference obtained by subtracting the previous browsing speed from the browsing speed of this time reaches a necessity of adjusting the message hold time 300, the message hold time 300 will be increased or reduced according to the fact that whether the difference (obtained by subtracting the previous browsing speed from the browsing speed of this time) is smaller than zero, and the time to be increased or reduced is the basic hold time parameter 310, i.e., 2 seconds.

As shown in FIG. 3, when the difference is smaller than zero, it indicates that the response from the user is faster than the last time (i.e., the browsing speed of this time is higher than the previous browsing speed ), and therefore, the message hold time 300 may be reduced. At this point, the basic hold time parameter 310 is subtracted from the original message hold time 300 to achieve a new message hold time 300. If the aforementioned assumption is still available, the new message hold time 300 is changed from the original 5 seconds to 3 seconds (i.e., 2 seconds are subtracted from 5 seconds). On the contrary, when the difference is greater than zero, it indicates that the response from the user is slower than the last time (i.e., the browsing speed of this time is lower than the previous browsing speed), and therefore, the message hold time 300 may be increased. At this point, the basic hold time parameter 310 is added to the original message hold time 300 to achieve a new message hold time 300. If the aforementioned assumption is still available, the new message hold time 300 is changed from the original 5 seconds to 7 seconds (i.e., 2 seconds are added to 5 seconds).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for adjusting message hold time, used to adjust a message hold time for displaying a message, comprising:
a detection and operation module, for activating a counter unit to count time when detecting that a message is triggered, making the counter unit stop counting when receiving a response of operation of a user, and calculating a browsing speed of this time;
a comparison module, storing a previous browsing speed, for comparing the browsing speed of this time with the previous browsing speed to acquire a difference; and
an adjusting module, for adjusting the message hold time according to the difference.

2. The system for adjusting message hold time as claimed in claim 1, further comprising a parameter setting module for storing a basic hold time parameter, wherein the basic hold time parameter is a basic adjustment unit for adjusting the message hold time, and is a time unit including minute, second, microsecond, and millisecond, or a percentage of browsing time.

3. The system for adjusting message hold time as claimed in claim 1, wherein the browsing speed of this time and the previous browsing speed refer to that the browsing time is divided by a total number of separate words, a total number of message lines, and a total number of message pages in a message, or a total number of separate words, a total number of message lines, and a total number of message pages are divided by the browsing time.

4. The system for adjusting message hold time as claimed in claim 1, wherein a predetermined threshold value is set in the comparison module, when an absolute value of the difference is smaller than the predetermined threshold value, the adjusting module is disabled to stop adjusting the message hold time.

5. The system for adjusting message hold time as claimed in claim 4, wherein:
when the difference is smaller than zero, the basic hold time parameter is subtracted from the message hold time; and
when the difference is greater than zero, the basic hold time parameter is added to the message hold time.

6. The system for adjusting message hold time as claimed in claim 1, wherein the adjusting module further requests the comparison module to replace the originally stored previous browsing speed with the browsing speed of this time after the message hold time is adjusted.

7. The system for adjusting message hold time as claimed in claim 1, wherein the adjusting module further stores the adjusted message hold time after the message hold time is adjusted.

8. The system for adjusting message hold time as claimed in claim 1, wherein the detection and operation module further disables the adjusting module to stop adjusting the message hold time when the browsing speed of this time is calculated to be an abnormal event.

9. A method for adjusting message hold time, used to adjust a message hold time for displaying a message, comprising the steps of:
activating counting time when the message is detected to be triggered;
stopping counting time when a response of operation of a user is received, and calculating a browsing speed of this time;
comparing the browsing speed of this time with a prestored previous browsing speed, so as to acquire a difference; and
adjusting the message hold time according to the difference.

10. The method for adjusting message hold time as claimed in claim 9, further comprising a step of storing a basic hold time parameter in advance, wherein the basic hold time parameter is a basic adjustment unit for adjusting the message hold time, and is a time unit including minute, second, microsecond, and millisecond, or a percentage of browsing time.

11. The method for adjusting message hold time as claimed in claim 9, wherein the browsing speed of this time and the previous browsing speed refer to that the browsing time is divided by a total number of separate words, a total number of message lines, and a total number of message pages in a message, or a total number of separate words, a total number of message lines, and a total number of message pages are divided by the browsing time.

12. The method for adjusting message hold time as claimed in claim 9, wherein the step of adjusting the message hold time according to the difference further comprising a step of stopping adjusting the message hold time when an absolute value of the difference is smaller than a predetermined threshold value.

13. The method for adjusting message hold time as claimed in claim 12, wherein the step of adjusting the message hold time according to the difference further comprising the steps of:
when it is determined that the difference is smaller than zero, subtracting the basic hold time parameter from the message hold time; and
when it is determined that the difference is greater than zero, adding the basic hold time parameter to the message hold time.

14. The method for adjusting message hold time as claimed in claim 9, further comprising a step of replacing the originally stored previous browsing speed with the browsing speed of this time after the message hold time is adjusted.

15. The method for adjusting message hold time as claimed in claim 9, further comprising a step of storing the adjusted message hold time after the message hold time is adjusted.

16. The method for adjusting message hold time as claimed in claim 9, further comprising a step of stopping adjusting the message hold time when the browsing speed of this time is abnormal.
